(19) United States
(12) Patent Application Publication
(10) Pub. No.: US 2025/0221381 A1
(43) Pub. Date: Jul. 10, 2025

(54) PET LEASH

(71) Applicants: Jennifer Velasquez Morse, San Clemente, CA (US); Cooper Wyatt Morse, San Clemente, CA (US)

(72) Inventors: Jennifer Velasquez Morse, San Clemente, CA (US); Cooper Wyatt Morse, San Clemente, CA (US)

(21) Appl. No.: 18/920,617

(22) Filed: Oct. 18, 2024

Related U.S. Application Data
(63) Continuation of application No. 18/134,478, filed on Apr. 13, 2023.
(60) Provisional application No. 63/330,714, filed on Apr. 13, 2022.

(51) Int. Cl. A01K 27/00

(52) U.S. Cl. CPC A01K 27/004; A01K 27/008

(57) ABSTRACT

A pet leash system includes a cord comprising a length of material extending from a pet end to a handler end, a hook connected to the cord at the pet end of the cord, the hook being adapted to connect the pet leash system to a pet to be walked by a handler, a graspable member at the handler end, the graspable member being adapted to be grasped by the handler so the handler can control a pet connected to the hook, and an accessory attachment mechanism in or on the pet leash system, such as in or on the cord. The accessory attachment mechanism is adapted to allow a handler to attach one or more accessories to the pet leash system so the accessories can be accessed while the handler is walking the pet.

### PRIORITY

The present application is a Continuation-In-Part of U.S. patent application Ser. No. 18/134,478, filed on Apr. 13, 2023, which claims the benefit of domestic priority based on U.S. Provisional Patent Application 63/330,714 filed on Apr. 13, 2022, the entireties of both of which are incorporated herein by reference.

### BACKGROUND

While owning and caring for a pet can be one of the most rewarding experiences in a person's life, the act of walking the pet can sometimes be a frustrating one. This is especially true when additional items or accessories need to be carried by the pet walker.

Many pets, particularly dogs, need to be regularly walked in order to give the pet exercise and stimulation and to allow the pet to urinate and/or defecate. To walk a pet, a pet walker will often connect a leash to the pet's collar or harness to tether the pet and prevent the pet from running away from the pet walker. The leash typically has a connection end for connecting to the pet and an opposite end including a loop or handle that can be grasped by the pet walker. Difficulties can occur, however, when the pet walker needs use of his or her hands for other tasks and/or when additional items need to be carried during the pet walking activity. During the pet walk, the hands of the pet walker are usually preoccupied with holding the leash and controlling the pet. This can be problematic when items such as empty or full waste bags, hand sanitizer, portable water bowls or other accessories are needed to be carried on the walk.

Leashes or other systems for holding an item during a pet walk have been developed. However, the available systems have not proven to be satisfactory. For example, some systems are limited to holding one specific accessory and are thus not adaptable to different types of accessories. Some systems have accessory attachments in locations that are not convenient and/or that interfere with the holding of the leash or the control of the pet. There are also products that come in the form of a waist or fanny bag for holding an accessory. This is not only more costly in that multiple products must be purchased by the pet walker, but it is also easy for the pet walker to forget the additional item when a walk begins.

Therefore, there is a need for a pet leash that easily and conveniently allows for the carrying of pet walk related accessories. There is further a need for a pet leash system having a handle or housing that allows for the carrying of pet walk related accessories in or on the pet leash handle or housing. There is a further need for a pet leash to allow for carrying of pet walk related accessories in or on a pet leash cord.

### SUMMARY

The present invention satisfies these needs. In one aspect of the invention, an improved pet leash system is provided.

In another aspect of the invention, an improved pet leash system with a handle or housing is provided.

In another aspect of the invention, an improved pet leash system without a handle housing is provided.

In another aspect of the invention, a pet leash handle housing, grippable member, and/or cord allows for the carrying of one or more pet walk related accessories in or on the housing.

In another aspect of the invention, a pet leash system includes a pet leash cord that includes an accessory attachment mechanism that allows for the carrying of one or pet walk related accessories.

In another aspect of the invention, a pet leash system includes a pet leash cord that includes an accessory attachment mechanism that allows for the carrying of one or pet walk related accessories, the accessory attachment mechanism comprising one or more apertures that extend through the cord.

In another aspect of the invention, a pet leash system includes a pet leash cord that includes an accessory attachment mechanism that allows for the carrying of one or pet walk related accessories, wherein the accessory attachment mechanism comprises one or more attachment members, wherein the one or more attachment members comprises one or more of an aperture, a hook, a magnet, a snap, a button, a hook and look fastener, and the like.

In another aspect of the invention, a pet leash system includes a pet leash cord that includes an accessory attachment mechanism that allows for the carrying of one or pet walk related accessories, wherein the pet leash system further comprises one or more of the accessories.

In another aspect of the invention, a pet leash system includes a pet leash cord that includes an accessory attachment mechanism that allows for the carrying of one or pet walk related accessories, wherein the pet leash system further comprises one or more of the accessories and/or one or more connectors that allow the one or more accessories to be attached to the accessory attachment mechanism.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on the cord, wherein the accessory attachment mechanism is adapted to allow a handler to attach one or more accessories to the pet leash system so the accessories can be accessed while the handler is walking the pet.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on the cord, wherein the accessory attachment mechanism is adapted to allow a handler to attach one or more accessories to the pet leash system so the accessories can be accessed while the handler is walking the pet, wherein the graspable member is a loop that is an extension of the cord.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on the cord, wherein the accessory attachment mechanism is adapted to allow a handler to attach one or more accessories to the pet leash system so the accessories can be accessed while the handler is walking the pet, wherein the accessory attachment mechanism includes at least a portion that is positioned on the graspable member.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on the cord, wherein the accessory attachment mechanism is adapted to allow a handler to attach one or more accessories to the pet leash system so the accessories can be accessed while the handler is walking the pet, wherein the accessory attachment mechanism includes at least a portion that is positioned on the graspable member, wherein the pet leash system further comprises one or more accessories, wherein the one or more accessories are adapted to be attached to the pet leash system using the accessory attachment mechanism.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on a body of the cord that extends between the hook and the graspable member, the graspable member, or both, wherein the accessory attachment mechanism is adapted to allow a handler to attach one or more accessories to the pet leash system so the accessories can be accessed while the handler is walking the pet.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on a body of the cord that extends between the hook and the graspable member, the graspable member, or both, wherein the accessory attachment mechanism is adapted to allow a handler to attach one or more accessories to the pet leash system so the accessories can be accessed while the handler is walking the pet, wherein the graspable member is a loop that is an extension of the cord.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on a body of the cord that extends between the hook and the graspable member, the graspable member, or both, wherein the accessory attachment mechanism is adapted to allow a handler to attach one or more accessories to the pet leash system so the accessories can be accessed while the handler is walking the pet, wherein the graspable member is a loop that is an extension of the cord and wherein the loop is positionable around the waist or other body part of a handler so that the pet leash system can be secured in a hands free manner.

In another aspect of the invention, a pet leash system comprises a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on a body of the cord that extends between the hook and the graspable member, the graspable member, or both, wherein the accessory attachment mechanism is adapted to allow a handler to attach one or more accessories to the pet leash system so the accessories can be accessed while the handler is walking the pet, wherein the pet leash system is a multi-pet leash system adapted to attach to multiple pets.

In another aspect of the invention, a method of walking a pet comprises providing a pet leash system, the pet leash system comprising: a cord comprising a length of material extending from a pet end to a handler end; a hook connected to the cord at the pet end of the cord, the hook being adapted to connect the pet leash system to a pet to be walked by a handler; a graspable member at the handler end, the graspable member being adapted to be grasped by the handler so the handler can control a pet connected to the hook; and an accessory attachment mechanism in or on the cord, connecting the hook to a pet, attaching one or more accessories to the cord, and grasping the graspable member and walking the pet with the one or more accessories attached to the cord.

In another aspect of the invention, a method of walking a pet comprises providing a pet leash as described herein and using the pet leash as described herein.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic side view of a version of a pet leash system of the present invention;

FIG. 2 is a schematic side view of another version of a pet leash system of the invention;

FIG. 3 is a schematic perspective view of the pet leash system of FIG. 2;

FIG. 4A is a schematic perspective view of another version of a pet leash system of the invention;

FIG. 4B is a partial schematic perspective view of another version of the pet leash system of FIG. 4A;

FIG. 4C is a partial schematic perspective view of another version of the pet leash system of FIG. 4A;

FIG. 5 is a schematic side view of another version of a pet leash system of the invention;

FIG. 6 is a schematic side view of another version of a pet leash system of the invention;

FIG. 7 is a schematic side view of another version of a pet leash system of the invention;

FIG. 8 is a schematic perspective view of another version of a pet leash system of the invention;

FIG. 9 is a schematic perspective view of another version of a pet leash system of the invention;

FIG. 10 is a schematic perspective view of another version of a pet leash system of the invention;

FIG. 11 is a schematic perspective view of another version of a pet leash system of the invention;

FIG. 12 is a schematic perspective side view of the version of a pet leash system of FIG. 11 holding one or more accessories;

FIG. 13 is a schematic perspective side view of the version of a pet leash system of FIG. 11 holding one or more accessories;

FIG. 14 is a schematic perspective view of another version of a pet leash system of the invention;

FIG. 15 is a schematic perspective view of another version of a pet leash system of the invention;

FIG. 16 is a schematic perspective view of another version of a pet leash system of the invention;

FIG. 17 is a schematic perspective view of another version of a pet leash system of the invention;

FIG. 18 is a schematic perspective view of another version of a pet leash system of the invention;

FIG. 19 is a schematic perspective view of another version of a pet leash system of the invention;

FIG. 20A is a schematic perspective view of a portion of another version of a pet leash system of the invention;

FIG. 20B is a schematic perspective view of a portion of another version of a pet leash system of the invention;

FIG. 20C is a schematic perspective view of a portion of another version of a pet leash system of the invention;

FIG. 20D is a schematic perspective view of a portion of another version of a pet leash system of the invention;

FIG. 20E is a schematic perspective view of a portion of another version of a pet leash system of the invention;

FIG. 21A is a schematic perspective view of a portion of another version of a pet leash system of the invention;

FIG. 21B is a schematic perspective view of a portion of another version of a pet leash system of the invention;

FIG. 21C is a schematic perspective view of a portion of another version of a pet leash system of the invention;

FIG. 21D is a schematic perspective view of a portion of another version of a pet leash system of the invention; and

FIG. 22 is a schematic perspective view of another version of a pet leash system of the invention.

### DESCRIPTION

The present invention relates to a pet leash system. In particular, the invention relates to pet leash system that allows for the carrying of one or multiple pet walk related accessories in or on the pet leash system. Although the invention is illustrated and described in the context of being useful for pet walking, such as dog walking, the present invention can be used in other ways, as would be readily apparent to those of ordinary skill in the art. Accordingly, the present invention should not be limited just to the examples and embodiments described herein.

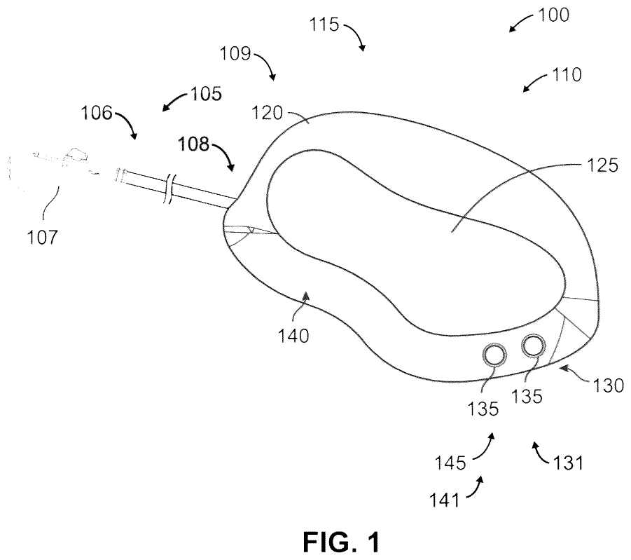

FIG. 1 shows a pet leash system 100 according to the invention. The pet leash system 100 includes a pet leash cord 105, also known as a lead, which is an at least partially length of flexible material that may be connected at a pet end 106 to a pet in need of a walk or that needs to be otherwise controlled or retrained. While the pet to be walked will often be a dog that is to be walked by the pet's handler, such as an owner, caregiver, or assistant, by pet it is meant any animal that is to be walked or restrained whether or not the animal is owned or controlled by the pet walker and whether or not the animal is living, mechanical, robotic, or otherwise. The pet end 106 of the pet leash cord 105 will include a hook 107, such as a snap clip, carabiner clip, other type of clasp, or the like as is conventionally known for connecting the pet end 106 of the pet leash cord 105 to the pet to be walked, such as by connecting the hook 107 to the pet's collar or harness. The pet leash cord 105 can be flat or round and is generally flexible and can be made of conventional materials used for pet leashes. At a handler end 108 of the pet leach cord 105, which is opposite the pet end 106, the pet leash cord 105 is connected to a graspable member 109 that enables a pet handler or walker to grasp and control the pet leash system 100. In the version of FIG. 1, the graspable member 109 is in the form of a housing 110 that includes a graspable portion that is graspable by a pet handler walker who is or will be handling or walking the pet. In the version of FIG. 1, the housing 110 includes a pet leash handle portion 115 on or as part of a housing body 120 of the housing 110. The housing body 120 or handle body has a handle opening 125 that is sized and shaped to receive at least a portion of the hand of the pet walker so that the pet walker and easily and securely hold the handle portion 115 at a graspable portion formed by the handle opening 125 to thereby control the pet during the pet walk.

As also shown in the version of FIG. 1, the pet leash housing body 120 also includes an accessory attaching mechanism 130. The accessory attaching mechanism 130 is designed to allow one or more pet walk related accessories to the carried and/or stored in or on the pet leash housing 110. For example, the pet walk related accessory can be one or more of an empty pet waste bag, a pet waste bag containing pet waste, hand sanitizer, sanitizing wipes, a portable water bowl, a container for snacks or treats, flashlight, reflector, pepper/citronella spray, whistle, small water container, keys or keychain, sunscreen, and the like. By being able to carry the one or more pet walk related accessories in or on the housing 110, the pet walker will not have to use a hand or other means to carry the accessory thereby freeing up the hands to carry other items and/or for controlling the pet. In addition, the pet walker can optionally store the one or more pet walk related accessory in or on the pet leash housing 110 when the pet leash housing 115 is not being used to assure that the one or more accessories are easily and readily available the next time the leash system 100 is to be used to walk a pet.

The accessory attaching mechanism 130 can comprise one or more attachment members 131. In the particular version of FIG. 1, the one or more attachment members 131 comprises one or more apertures 135, such as a hole or opening, that extend into and/or through the housing body 120. For example, in the version shown, each of the one or more apertures 135 extends laterally at least mostly through and preferably entirely through the housing body 120 from a left side outer surface 140 to the opposite right side outer surface. In one version, the one or more apertures 135 extends substantially in the same direction as the handle opening 125 and transverse to the direction of the leash 105 as it extends from the housing body 120. In another version, the one or more apertures 135 extend in a different direction. Also, as in the version shown, the one or more apertures 135 is a plurality of attachment members 141, which in the version of FIG. 1 is a plurality of apertures 145. By providing a plurality of apertures 145, a plurality of pet walk related accessories may be carried. Each of the apertures 135 in the plurality of apertures 145 can be the same or can be different and can extend in the same or in different directions.

The one or more apertures 135 may be sized and shaped to be adapted to carry a particular pet walk related accessory or to carry one of a variety of pet walk related accessories. For example, by providing an aperture that has a diameter or equivalent cross-sectional dimension of from about 0.125 inches to about 6 inches, or from about 0.25 inches to about 4 inches, or from about 0.33 inches to about 2 inches, or from about 0.5 inches to about 1 inch, the aperture 135 has the ability to be used in a variety of ways. For example, the aperture 135 can be used to hold a bag that has been inserted therethrough or can be used to carry a string, handle, or hook for a different accessory. By equivalent dimension herein and throughout it is meant that if the circular cross-section or shape were to be replaced with a non-circular cross-section or shape, the equivalent dimension would be the dimension of the non-circular cross-section or shape that results in an area calculation that is generally the same as the area of the circular cross-section or shape. By way of hypothetical example, a 1 mm diameter cross-section or circular shape would have an area of about 0.8 mm2 and a square shaped cross-section or shape would have an equivalent cross-sectional area also of about 0.8 mm2 which would mean the length of the sides of the square is about 0.9 mm. While the one or more apertures 135 are shown as being circular in cross-section, they can be any cross-sectional shape of equivalent dimension. For example, the one or more apertures 135 can be oval, ovoid, rounded, egg-shaped, square, rectangular, trapezoidal, any other polygonal shape, any other substantially polygonal shape that includes rounded portions, a combination of any of these shapes, or the like. While the one or more apertures 135 can be located and positioned anywhere on the housing body 120, in one particular version, each of the one or more apertures 135 extends laterally through the housing body 120 from an opening in the left side outer surface 140 to an opening in the opposite right side outer surface. In this version, the one or more apertures 135 extends through the thickness of the housing body 120 and thus has a length from the left side opening to the right side opening of at least 0.1 inches at least about 0.2 inches or at least about 0.5 inches or at least about 0.75 inches.

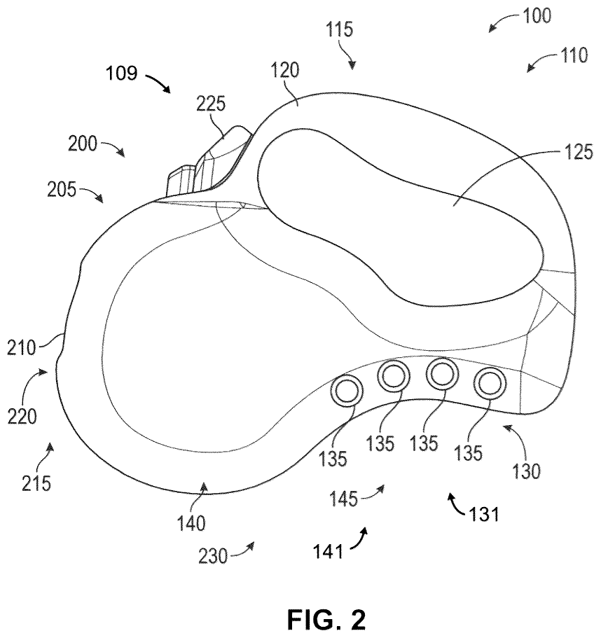

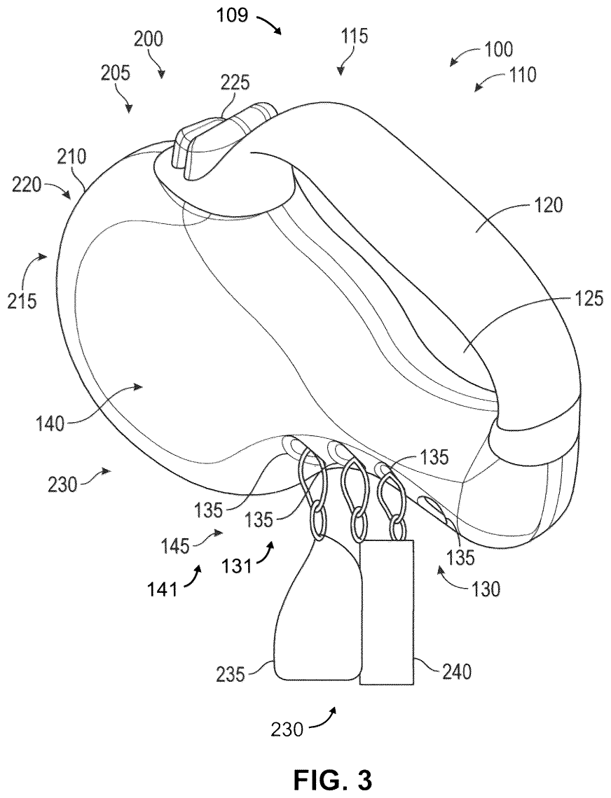

FIGS. 2 and 3 show another version of a pet leash housing 110 of a pet leash system 100 of the invention. In this version, the pet leash housing 110 is a retractable handle 200 that includes a retraction mechanism 205 within its interior. The pet leash cord 105 (not shown in FIG. 2 for clarity) extends from an opening 210 in the front 215 of the retractable handle 200. Internally, the pet leash cord 105 is wound around a retraction member 220 that is controlled by a button 225 that selectively allows the pet leash cord 105 to be extended or retracted. Retraction mechanisms 205 of the type shown are conventionally known in the art. The housing body 120 is made of a rigid or semi-rigid material sufficiently strong to support the retraction mechanism 205 and to handle the stresses applied during use of the pet leash housing 110. In one version, the housing body 120 comprises a hard outer shell made of polymer or the like, as is conventionally known.

As shown in FIGS. 2 and 3, the retractable handle 200 of the pet leash system 100 includes an accessory attachment mechanism 130 in that includes one or more apertures 135 as discussed in connection with FIG. 1. In the version, shown in FIGS. 2 and 3, the accessory attachment mechanism 130 includes a plurality of apertures 145, such as the four shown. The one or more apertures 135 may be positioned anywhere on the housing body 120. In the version of FIGS. 2 and 3, the one or more apertures 135 are positioned near the bottom of the housing body 120. In this location, the one or more apertures 135 can conveniently carry an accessory in a manner that does not interfere with the grasping and control of the pet leash system 100 by the pet walker or with the operation of the retraction mechanism 205. FIG. 3 shows the accessory attachment mechanism carrying one or more accessories, such as a first accessory 230 and/or a second accessory 240.

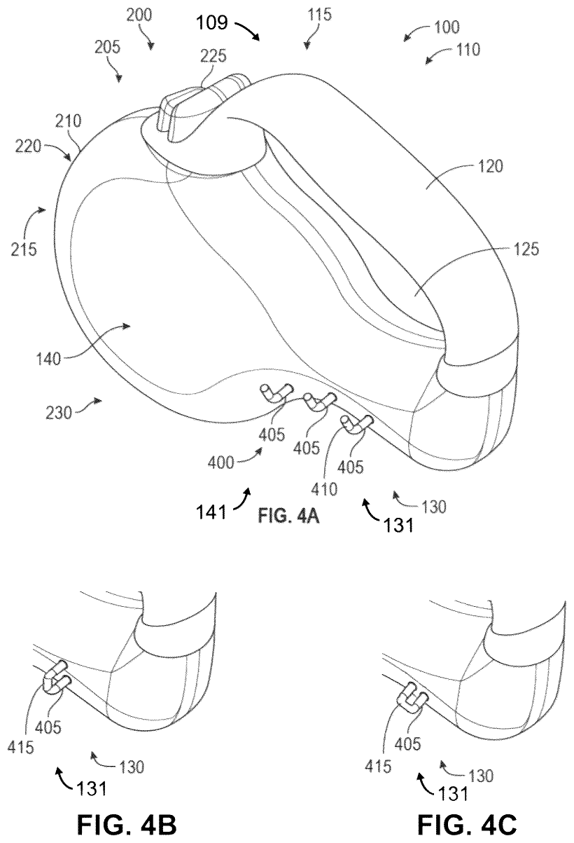

FIG. 4A shows another version of a pet leash system 100 of the invention. The version of FIG. 4A is similar to the version of FIGS. 2 and 3 except that in the version of FIG. 4A the accessory attachment mechanism comprises one or more protruding members 400, such as one or more hooks 405 that replace or are provided in addition to the one or more apertures 135. The one or more hooks 405 can include upwardly extending portions 410 or can extend straight out. The one or more pet walk accessories can be hooked onto a hook 405 or a handle or string for the accessory can be hooked onto a hook 405. In the version shown, the one or more hooks 405 extend laterally outwardly from the left side surface 140 and/or the right side surface of the housing body 120. FIG. 4B shows a variation of the version of FIG. 4A where the one or more hooks 405 is a closed ring 415 that extends substantially in the up and down direction to create an opening that extends substantially in the front to back direction of the housing body 120. FIG. 4C shows another version of the closed ring 415 with the closed ring 415 extending in a front to back direction to create an opening that extends in the up and down direction. Alternatively, the closed ring 415 can be an any angle between that which is shown in FIG. 4B and 4C, and the closed rings can be located at other positions on the housing body 120 such extending downwardly from the bottom surface of the housing body 120.

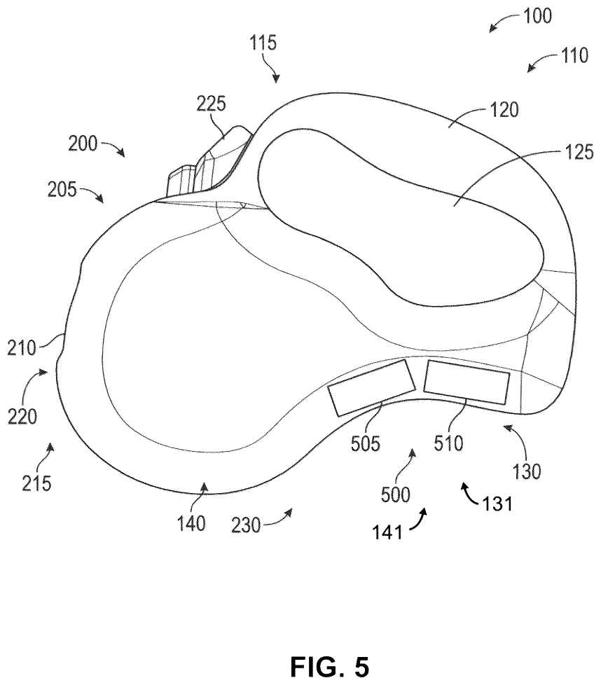

Another version of a pet leash system 100 is shown in FIG. 5. In this version, the accessory attachment mechanism 130 comprises one or more magnets 500 positioned on the housing body 120. For example, the one or more magnets 500 can be positioned on the left side surface 140 and/or on the right side surface so that an accessory can be attached to the side of the housing body 120. The accessory to be carried on the housing body 120 can be provided with a magnet or a magnetic surface that is attracted to the one or more magnets 500. In the version shown in FIG. 5, the one or more magnets 500 comprises a plurality of magnets, such as a first magnet 505 and a second magnet 510. Alternatively, a single magnet or more than two magnets can be provided. In an alternative arrangement, a magnet can be provided on the accessory and the accessory attachment mechanism 130 can comprises a magnetic surface that is attracted to the magnet.

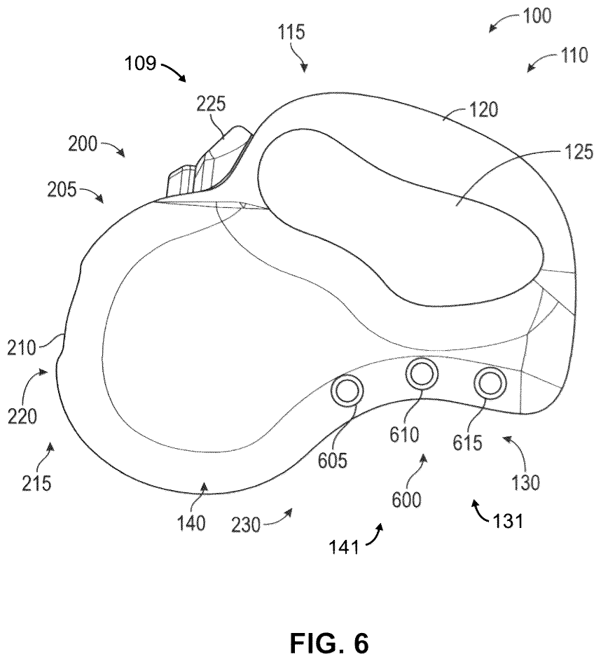

Another version of a pet leash system 100 is shown in FIG. 6. In this version, the accessory attachment mechanism 130 comprises one or more snaps 600 or buttons or the like positioned on the housing body 120. For example, the one or more snaps 600 can be positioned on the left side surface 140 and/or on the right side surface so that an accessory can be attached to the side of the handle body 130. The accessory to be carried on the housing body 120 can be provided with a mechanism that is engaged by the snaps 600 or buttons or the like. In the version shown in FIG. 6, the one or more snaps 600 or buttons or the like comprises a plurality of magnets, such as a first snap 605, a second snap 610, and a third snap 615. Alternatively, a single snap or two snaps can be provided or more than three can be provided. In an alternative arrangement, a snap or button or the like can be provided on the accessory and the accessory attachment mechanism 130 can comprises a member that receives the snap or button or the like.

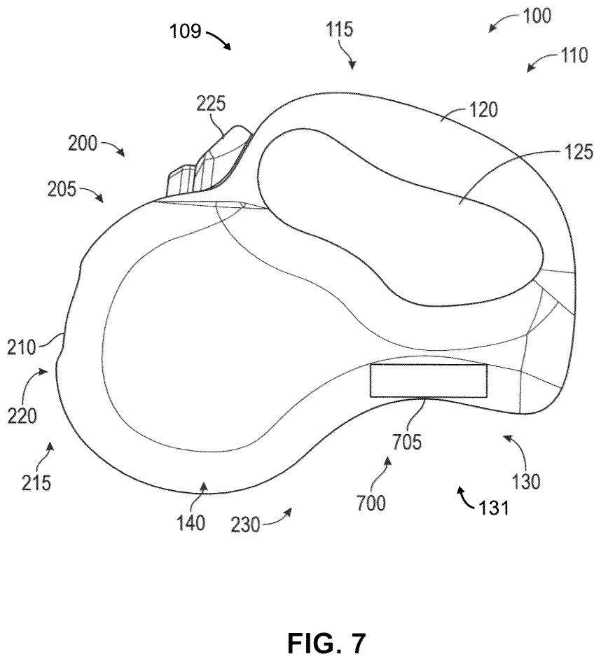

Another version of a pet leash system 100 is shown in FIG. 7. In this version, the accessory attachment mechanism 130 comprises one or more Velcro or other type of hook and loop fastener system 700 positioned on the housing body 120. For example, one side 705 of a hook and loop fastener 700 can be positioned on the left side surface 140 and/or on the right side surface so that an accessory can be attached to the side of the handle body 130. The accessory to be carried on the housing body 120 can be provided with the corresponding side of the hook and loop fastener system 700. In the version shown in FIG. 7, a single strip of the one side 705 is provided. One or more corresponding strips can be attached to the single strip. Alternatively, multiple first side strips 705 can be provided.

With any of the aforementioned versions, the number and location of the accessory attachment mechanisms can be anywhere on the housing body 120. Any combination of the types of the accessory attachment mechanisms can also be provided. Also, in a version of the invention, the accessory attachment mechanism can be located on a member that is removably attachable to the housing. The member can be attachable to the housing by a screw type arrangement, a sliding arrangement, a press-fit arrangement or the like. Also the handle portion can be removably attachable to the housing and/or can include an indentation or the like in place of a complete opening.

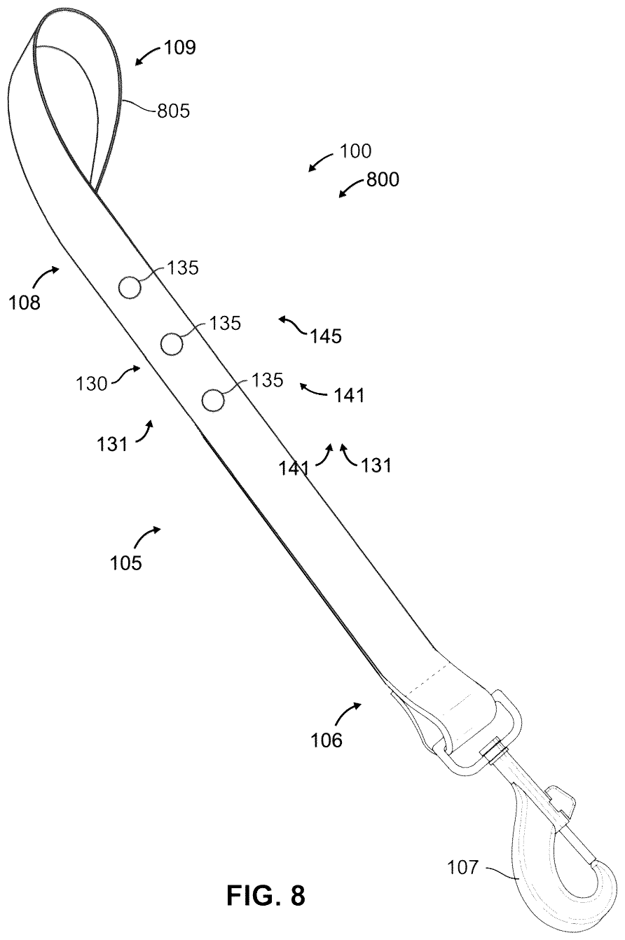

FIG. 8 shows another version of the pet leash system 100. In the version of FIG. 8, the pet leash system 100 is a cord-based accessory attachment pet leash system 800 wherein the accessory attachment mechanism 130 is provided in or on the cord 105 of the pet leash system 100 instead of or in addition to being provided on a housing. The cord 105, which is also often called a lead, flat lead, slip lead, rope, cable, or simply a leash, is the at least partially flexible piece of material or tether that connects a handler to a pet. It can be connected to a housing, such as shown in the above versions, or it can be absent a housing. In the version of FIG. 8, the graspable member 109 attached to the handler end 108 of the cord 105 is a loop 805 instead of a housing. In the version of

FIG. 8, the loop 805 is integrally formed as an extension of the cord 105 and is thus a part of the cord 105. Alternatively, the loop 805 can be replaced by a housing, such as a conventional retractable handle or other housing. In this version, the accessory attachment mechanism 130 is provided on the pet leash cord 105 itself. For example, in the version of FIG. 8 shown, the accessory attachment mechanism 130 comprises one or more apertures 135 that extend through the thickness of the cord 105, such as by being built-in rings on the cord 105 to which one or more accessories can be easily attached by either directly inserting the accessory or part of the accessory through one or more apertures 135 or by providing a connector that can connect to the aperture 135 or other attachment mechanism, as will be described. In the particular version shown, the accessory attachment mechanism 130 comprises a plurality of apertures 145. Alternatively or additionally, the accessory attachment mechanism 130 of the version of FIG. 8 can be any of the accessory attachment mechanisms discussed above or a combination thereof, such as any one or any combination of the accessory attachment mechanism 130 shown and discussed in connection with FIGS. 1, 2, 4A, 4B, 4C, 5, 6, and 7, but applied to the cord 105 instead of or in addition to the housing.

The pet leash system 100 of FIG. 8 allows a handler to be able to walk a pet, such as a dog, while carrying one or more accessories by use of the accessory attachment mechanism 130 of the pet leash system 100. The pet leash cord 105 in the version of FIG. 8 can be flat or round and is generally flexible and can be made of conventional materials used for pet leashes. In the version shown in FIG. 8, the one or more apertures 135, such as a hole or opening, extend into and/or through the cord 105. For example, in the version shown, each of the one or more apertures 135 extends at least mostly through and preferably entirely through the cord 105. In one version, the one or more apertures 135 extends substantially transverse to an axis that extends through the center of the loop 805 when the pet leash system 100 is outstretched. In another version, the one or more apertures 135 extend in a different direction. Also, as in the version shown, the one or more apertures 135 is a plurality of apertures 145. By providing a plurality of apertures 145, a plurality of pet walk related accessories may be carried. Each of the apertures 135 in the plurality of apertures 145 can be the same in terms of size and/or shape or can be different and can extend in the same or in different directions.

In the version of a pet leash system 100 in the form of a cord-based accessory attachment pet leash system 800 that includes one or more apertures 135 as the accessory attachment mechanism 130, the one or more apertures 135 may be sized and shaped to be adapted to carry a particular pet walk related accessory or to carry one or more of a variety of pet walk related accessories. For example, for a 1-inch wide cord 105, by providing an aperture that has an inner diameter or equivalent cross-sectional dimension of from about 0.1 inches to about 0.75 inches, or from about 0.2 inches to about 0.6 inches, or from about 0.25 inches to about 0.5 inches, or from about 0.3 inches to about 0.4 inches, the aperture 135 has the ability to be used in a variety of ways as an accessory attachment mechanism 130. The above ranges of dimensions can be adjusted according to the width of the cord 150. For example, for a cord 105 that has a width, w, in the region of an aperture 135, the inner diameter or equivalent cross-sectional dimension of one or more of the apertures according to one version can be from about 10 percent of w to about 75 percent of w, or from about 20 percent of w to about 60 percent of w, or from about 25 percent of w to about 50 percent of w, or from about 30 percent of w to about 40 percent of w. For example, for a cord 105 having a width of 0.75 inches in the region of an aperture 135, the inner diameter or equivalent cross-sectional dimension of one or more of the apertures 135 according to one version can be from about 0.075 inches to about 0.6 inches, or from about 0.15 inches to 0.45 inches, or from about 0.1875 inches to about 0.375 inches, or from about 0.2 inches to about 0.3 inches. In another particular version, the cord 105 may be in the form of a round rope, and the above percentages would apply with the w being the diameter or equivalent cross-sectional dimension of the rope. The length of the cord 105 can be any suitable length. In one version, the length can be from about 1 foot to about 100 feet. Commonly, the length of the cord 105 will range from about 3 feet to about 10 feet. The cord 105 can also include additional features, such as an addition loop along its length, often referred to as a traffic loop or traffic handle, that gives a handler an additional option for controlling a pet. The shape of the one or more apertures 125 can be selected for utilitarian or aesthetic purposes. For example, the aperture 135 can be shaped so that it can be used to hold a bag that has been inserted therethrough or can be used to carry a string, handle, hook, such as a carabiner, or the like for a different accessory. While the one or more apertures 135 are shown as being circular in cross-section, they can be any cross-sectional shape of equivalent dimension. For example, the one or more apertures 135 can be oval, ovoid, rounded, egg-shaped, square, rectangular, trapezoidal, any other polygonal shape, any other substantially polygonal shape that includes rounded portions, a combination of any of these shapes, or the like.

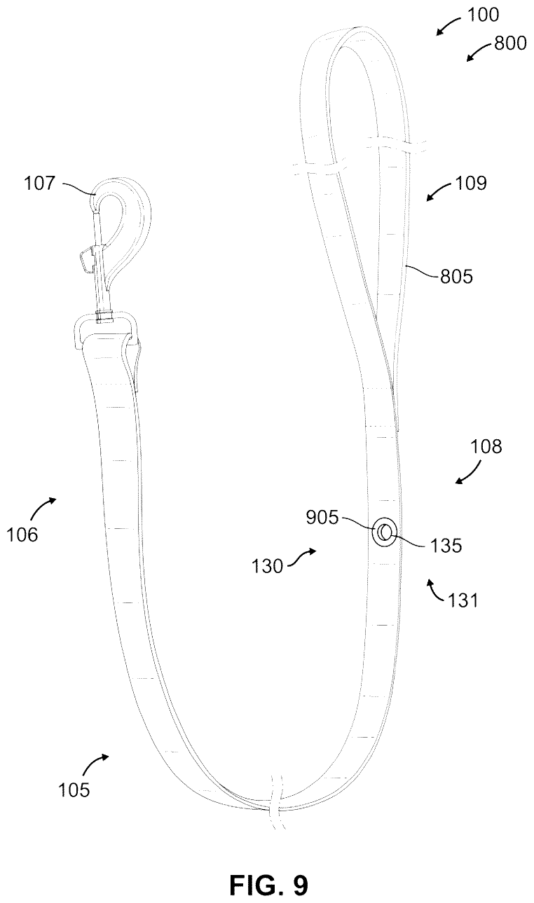

FIG. 9 shows another version of a pet leash system 100 in the form of a cord-based accessory attachment pet leash system 800. In the version of FIG. 9, the one or more apertures 135 of the accessory attachment mechanism 130 optionally includes a grommet 905 the inner surface of which forms an aperture. By grommet it is meant a ring or other-shaped strip that is inserted through a hole that extends through the cord 105. The grommet 905 may be smooth, flared, collared, grooved, or the like, and is typically made of metal, plastic, and/or rubber. The grommet 905 can help prevent an aperture 135 from becoming worn or frayed during use.

FIG. 9 also illustrates how the length of the cord 105 can vary and/or how the length or circumference of the loop 805 can vary. For example, the length or circumference of the loop 805 can be selected so that the loop 805 can fit comfortable in or around the hand or a portion of a hand such as a thumb of a handler. In this regard, the use of graspable does not mean that the graspable member is necessary actually grasped within the palm of a hand but that it mere can be grasped. In use, the graspable member 109 is often not actually grasped during use but is used to surround or otherwise be controllable by a body part. In another version, the length or circumference of the loop 805 can be selected so that the loop of the graspable member 109 can be positioned around the waist, shoulders, or other body part of the handler in a hands-free manner. In this latter version, a length adjustment system and/or a buckle or the like can optionally be provided.

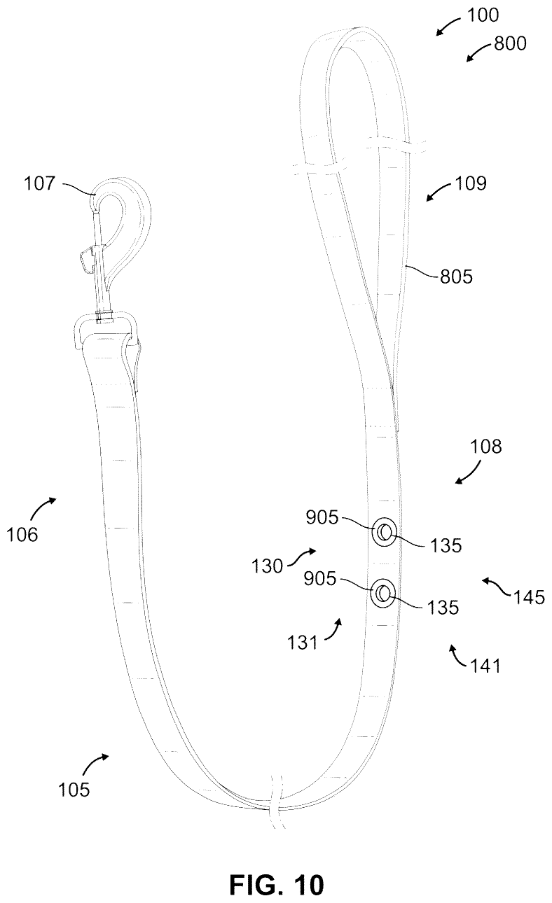

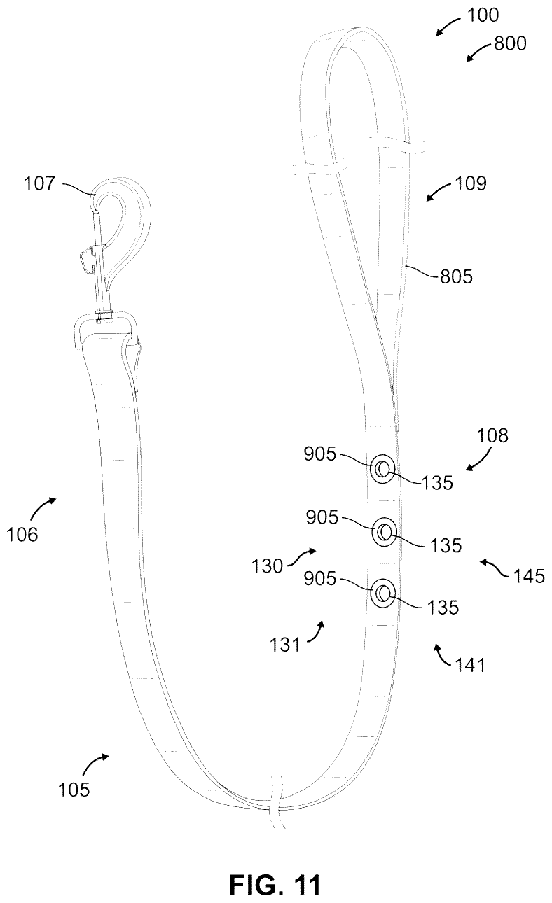

FIGS. 10 and 11 show alternative versions of a pet leash system 100 in the form of a cord-based accessory attachment pet leash system 800 that are similar to the version of FIG. 9. In the version of FIG. 10, a plurality of apertures 145 is provided, and in the version of FIG. 11, the plurality of apertures 145 includes three or more apertures. While the one more apertures 135 can be located and positioned anywhere on the cord 105 between the pet end 106 and the handler end 108, in the particular versions of FIGS. 9, 10, and 11 at least one of the one or more apertures 135 is positioned closer to the handler end 108 than to the pet end 106 to allow it to be easily access by a handler grasping the graspable member 109, such as the loop 805.

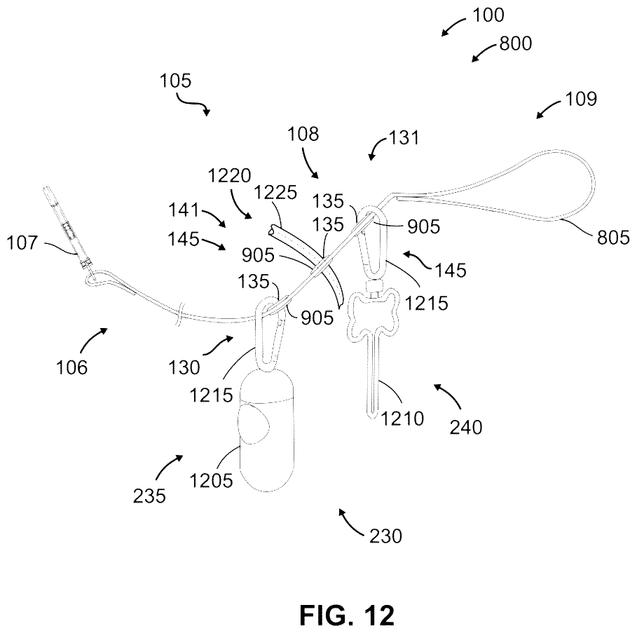

FIG. 12 shows the version of the pet leash system 100 of FIG. 11 in use. In FIG. 12, the pet leash system 100 is shown carrying one or more accessories 230, such as one or more of the accessories discusses above. In the particular version shown, the one or more accessories 230 includes a first accessory 235 in the form of a 1205 container 1205 that can carry an item, such as a treat, hand sanitizer, bags, and the like. Also in the particular version shown, a second accessory 240 is provided, which in this case is in the form of a pet poop bag holder 1210. The one or more accessories 230 can be connected to the accessory attachment mechanism 130 in this version by way of a connector 1215, which can be in the form of a hook, clip, clasp, string, rope, or the like that can be inserted through an aperture 135. In the particular version shown, the connector 1215 is in the form of a carabiner clip. The connector and/or one or more accessories 230 can be provided as part of the pet leash system 100 or can be separately provided. FIG. 12 additionally or alternatively also shows a third accessory 1220 in the form of an accessory that does not need a connector 1215 to be carried by the accessory attachment mechanism 130. For example, in the particular version show, the accessory is in the form of a flexible bag 1225 that can be directly inserted through an aperture 135 and held in place.

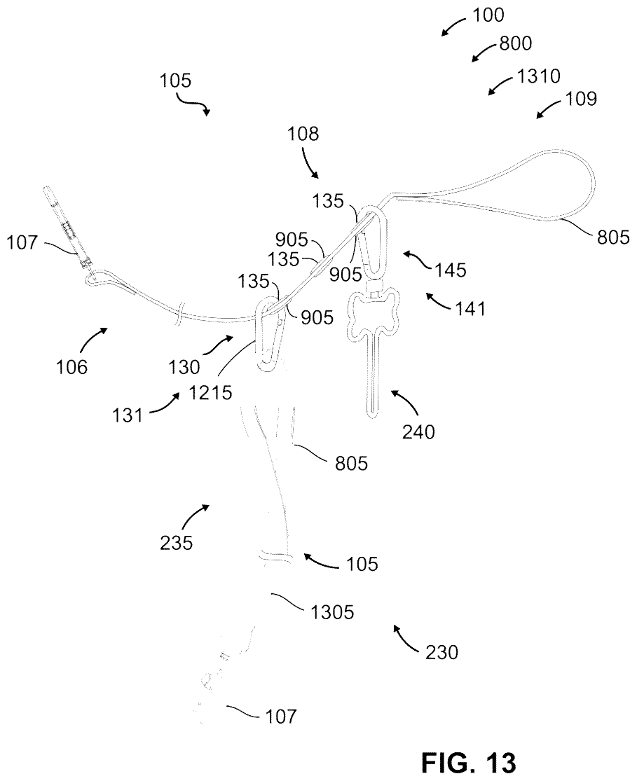

FIG. 13 shows a version similar to the version of FIG. 12. In the version of FIG. 13, one of the accessories 230 is an additional pet leash 1305. In this version, the additional pet leash 1305 can be attached to the pet leash system 100 by clipping the additional pet leash 1305 onto one or more of the apertures 135 or other forms of attachment of the accessory attachment mechanism 130 thus making the pet leash system 100 of FIG. 13 a multi-pet leash 1310. With this version, the pet leash system 100 can be converted to a multiple pet walking leash with each of the hooks 107 connected to a different pet. In the particular version shown, the connector 1215 is again shown in the form of a carabiner clip. In another version, the additional pet leash 1305 can be include a second hook 107 that can be used to clip into an aperture 135 on the cord 105 of the pet leash system 100. The additional leash 1305 can optionally also include an accessory attachment mechanism 130. Optionally, a third, fourth, or more additional pet leash 1305 can be provided and connected to the pet leash system 100.

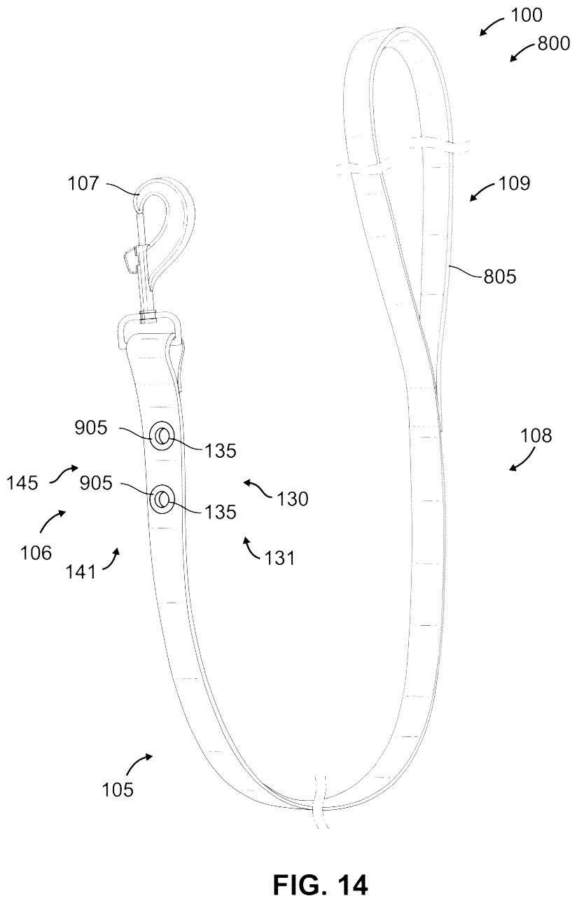

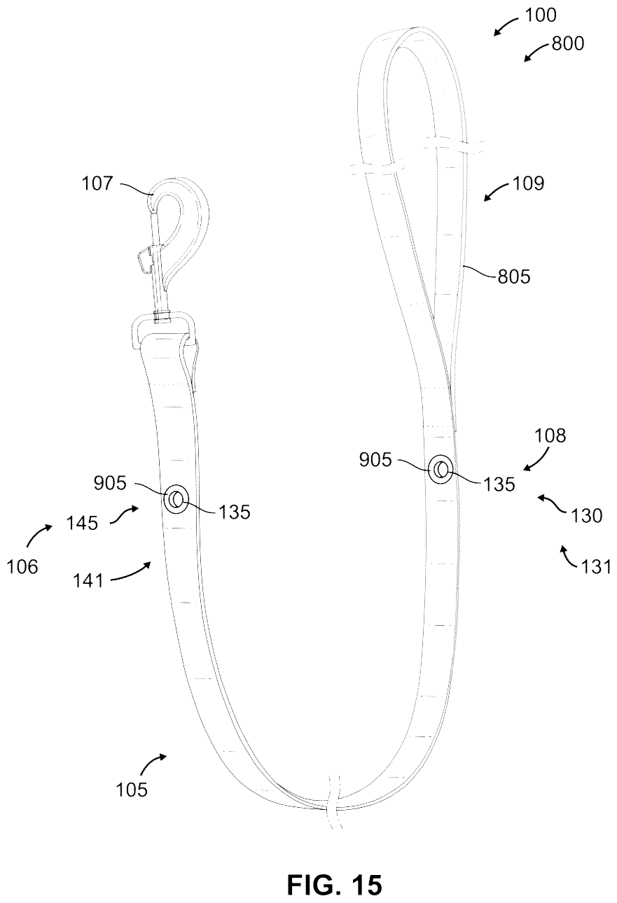

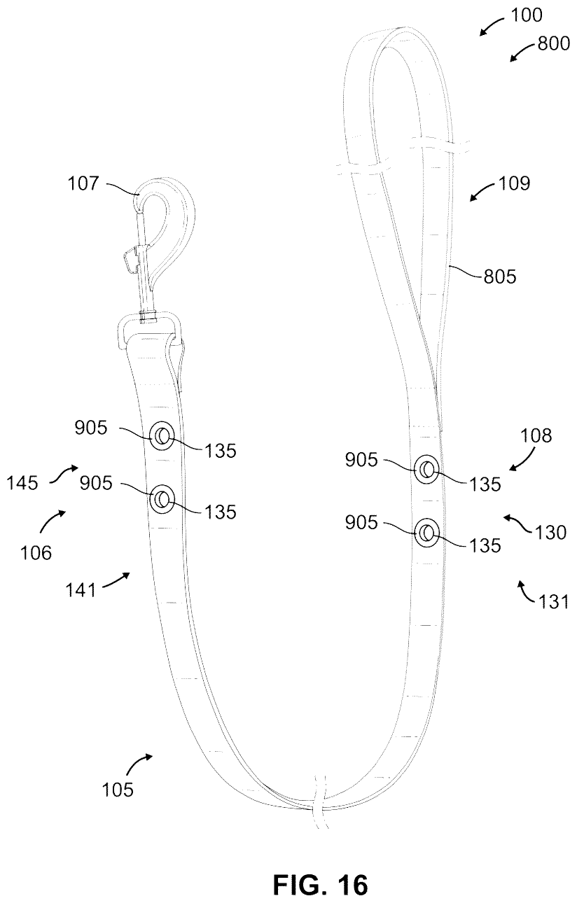

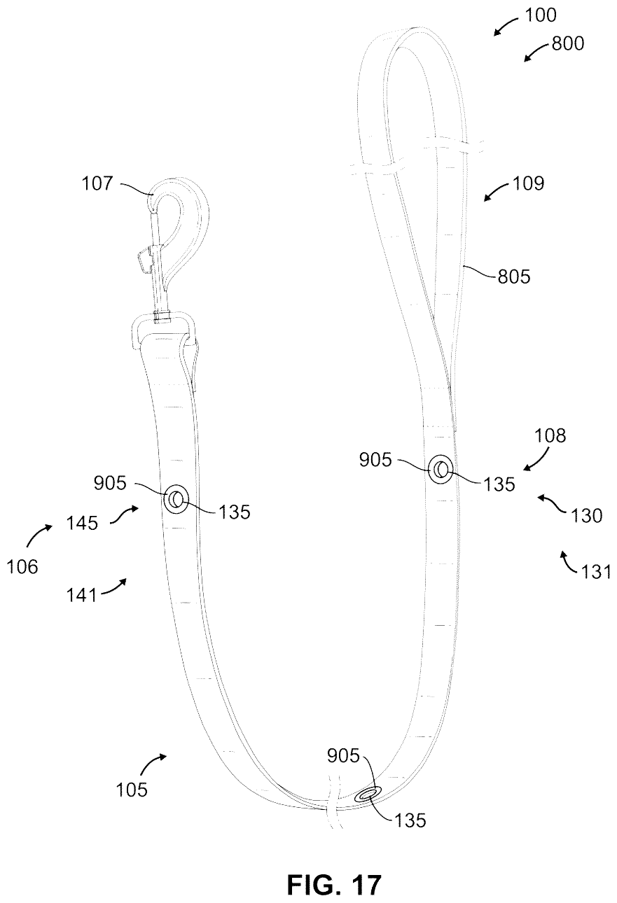

FIGS. 14 through 17 show alternative versions of a pet leash system 100 in the form of a cord-based accessory attachment pet leash system 800 that are similar to the version of FIG. 9, but with the accessory attachment mechanism 130 shown at different positions on the cord 105. For example, in the version of FIG. 14, the accessory attachment mechanism 130 is in the form of a plurality of apertures 145 positioned at the pet end 106 of the cord 105 in proximity to the hook 107. This version is particularly useful when the accessory to be carried is an accessory that would be convenient when carried close to the pet that is to be walked. In the version of FIG. 15, the plurality of apertures 145 includes one or more apertures on the handler end 108 and one or more apertures on the pet end 106 of the cord 105, and FIG. 16 shows a version with a plurality of apertures at the handler end 108 and a plurality of apertures at the pet end 106. FIG. 17 shows a version similar to FIG. 15 but with an additional one or more apertures 145 at an intermediate position. The version of FIG. 17 can be particularly useful when using the pet leash system 100 as a multi-pet leash, as shown in FIG. 13. The version of FIG. 17, or any of the other version, can also be useful when it is desired to shorten the length of the cord 105. This can be accomplished by using a connector 1215, such as one shown in FIG. 12, to connected two apertures together, thus folding a portion of the cord 105 over itself and effectively shortening the cord 105. In this version, the cord 105 itself is the one or more accessories 130.

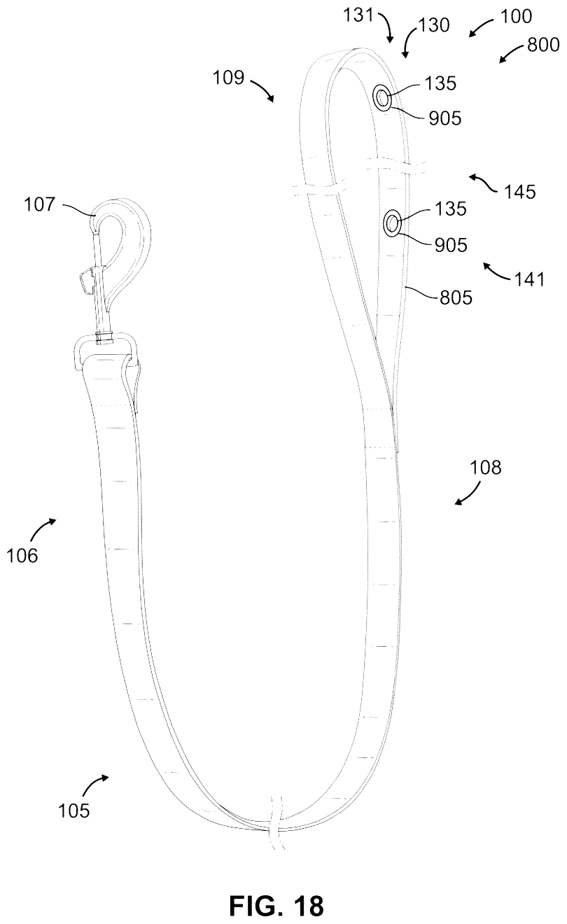

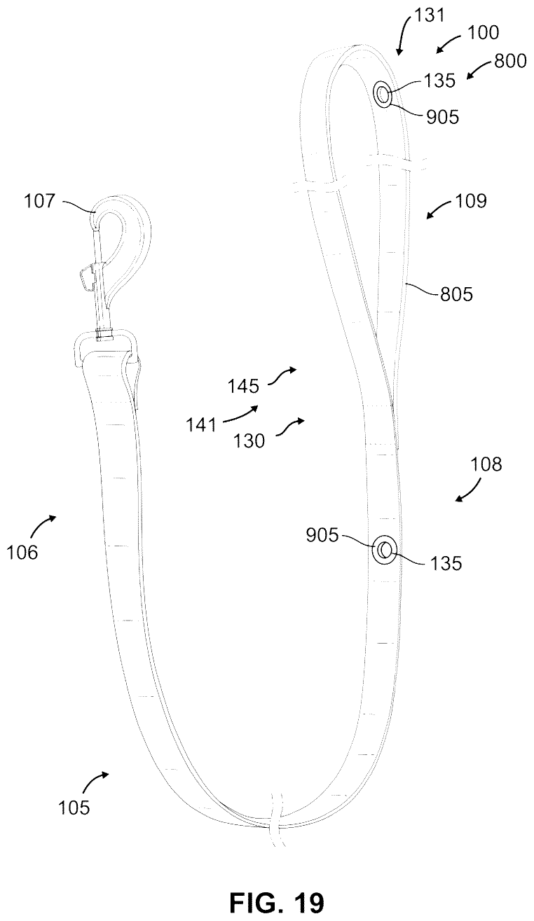

FIGS. 18 and 19 show alternative versions of a pet leash system 100 in the form of a cord-based accessory attachment pet leash system 800 that are similar to the version of FIG. 9. In the version of FIGS. 18 and 19, one or more apertures is provided in the cord 105 in the loop 805 of the pet leash system 100. In the version of FIG. 18, a plurality of apertures 135 are provided in the loop 805 of the cord 105. In the version of FIG. 19, one or more apertures 135 are provided are provided in the loop 805 of the cord 105 and one or more apertures are provided in the handle end 108 portion of the cord 105. The version of FIG. 19 is particularly useful when it is desired to secure the pet leash system 100 to an object, such as a pole. With this version, an aperture in the loop 805 can be connected to an aperture in the handler end 108 of the cord, such as by using a connector 1215 as shown in FIG. 12, with the cord encircling the object to be secured to. In this version, the loop 105 is the one or more accessories 130.

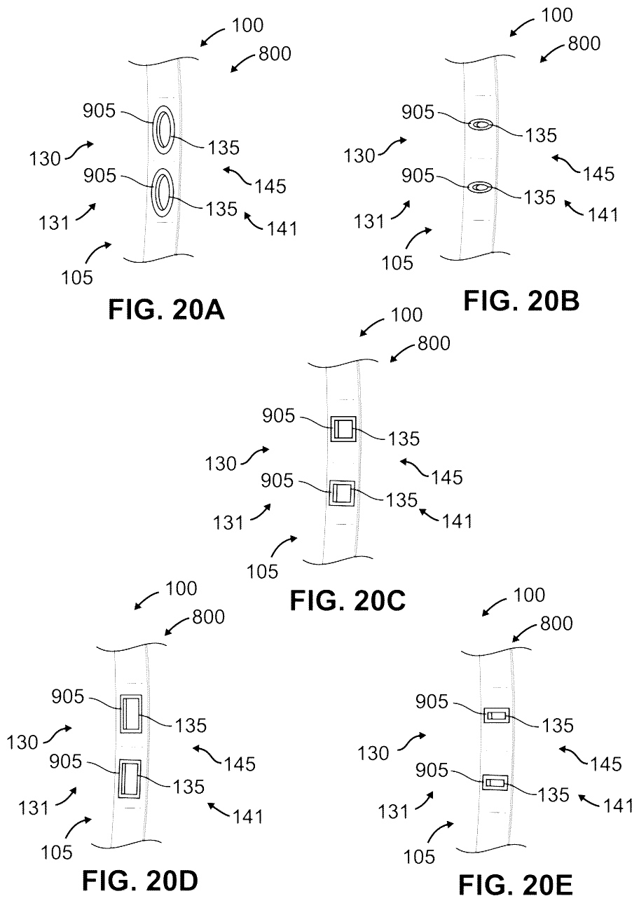

FIGS. 20A through 20E illustrate other versions of a pet leash system 100 in the form of a cord-based accessory attachment pet leash system 800. More specifically FIGS. 20A through 20E illustrate additional or alternative shapes for the one or more attachment members 131, such as the one or more apertures 135. For example, the one or more apertures 135, with or without a grommet 905, can be an oval extending lengthwise, as shown in FIG. 20A, or transversely, as shown in FIG. 20B. An aperture 135 in the form of a polygon is shown in FIGS. 20C, 20D, and 20E. The aperture is shown as a square in FIG. 20C, in the form of a lengthwise extending rectangle in FIG. 20D, and in the form of a transversely extending rectangle in FIG. 20E. The one or more apertures 135 can take on any other shape, as discussed above.

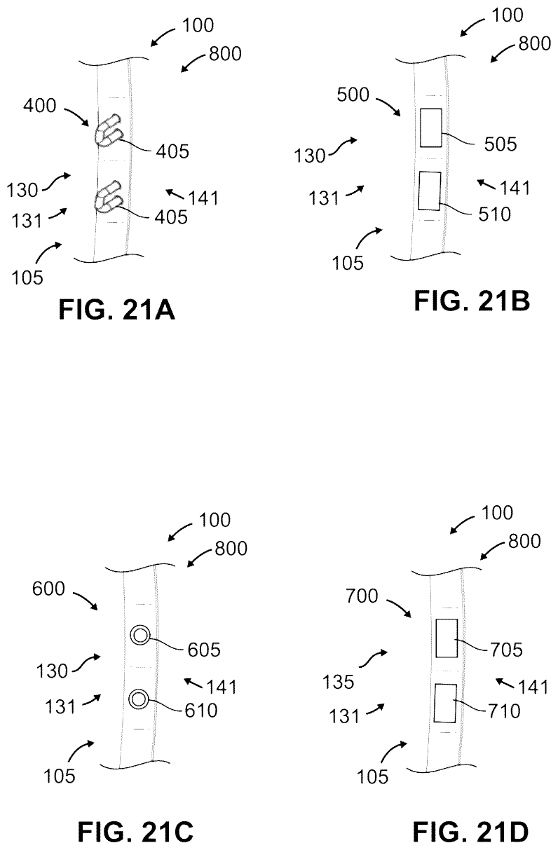

FIGS. 21A through 21D illustrate other versions of a pet leash system 100 in the form of a cord-based accessory attachment pet leash system 800. More specifically FIGS. 21A through 21D illustrate additional or alternative types of attachment members 131 that form the accessory attachment mechanism 130. For example, in the version of FIG. 21A, the attachment member 131 is a protruding member 400, such as one or more hooks 405 that can replace or are provided in addition to the one or more apertures 135. The one or more hooks 405 can be in a variety of forms and/or orientations, such as those discussed above in connection with FIG. 4. The one or more pet walk accessories can be hooked onto a hook 405 or a connector 1215 can be provided. The one or more hooks 405 can be rigid or flexible loops. In the version of FIG. 21B, the attachment members 131 of the accessory attachment mechanism 130 comprises one or more magnets 500 positioned on the cord 105. The accessory to be carried on by the accessory attachment mechanism 130 can be provided with a magnet or a magnetic surface that is attracted to the one or more magnets 500. When a plurality of hooks 405 are provided, two of the hooks 405 can be engageable with one another to adjust the length of the cord 105 and/or to form a loop, as discussed above, and/or a connector 1215 can be used for the purpose.

In the version shown in FIG. 21B, the one or more magnets 500 comprises a plurality of magnets, such as a first magnet 505 and a second magnet 510. Alternatively, a single magnet or more than two magnets can be provided. In one such version, a single magnet on the cord 105 can be adapted to attached two or more accessories. In an alternative arrangement, a magnet can be provided on the accessory and the accessory attachment mechanism 130 can comprises a magnetic surface that is attracted to the magnet. In one version, the first magnet 505 and the second magnet 510 can have opposing polarity. In this version, the two magnets can be engageable with one another to adjust the length of the cord 105 and/or to form a loop, as discussed above.

In the version of FIG. 21C, the one or more attachment members 131 of the accessory attachment mechanism 130 comprises one or more snaps 600 or buttons or the like positioned on the cord 105. The accessory to be carried on the housing body 120 can be provided with a mechanism that is engaged by the snaps 600 or buttons or the like. In the version shown in FIG. 6, the one or more snaps 600 or buttons or the like comprises a plurality of snaps, such as a first snap 605 and a second snap 610. Alternatively, a single snap or more than two snaps can be provided. In an alternative arrangement, a snap or button or the like can be provided on the accessory and the accessory attachment mechanism 130 can comprises a member that receives the snap or button or the like. In this version, the snaps 600 can be engageable with one another to adjust the length of the cord 105 and/or to form a loop, as discussed above.

In the version of FIG. 21D, the one or more attachment members 131 of the accessory attachment mechanism 130 comprises one or more Velcro or other type of hook and loop fastener system 700 positioned on the cord 105. The accessory to be carried on the cord 105 can be provided with the corresponding side of the hook and loop fastener system 700. In the version shown in FIG. 7, a first strip 705 of the hook and loop fastener is provided along with a second strip 710 of the hoop and loop fastener. Alternatively, a single strip can be provided that is adapted to connect two or more accessories. The first strip 705 and the second strip 710 can be the same side of a hook and loop fastener or can be opposite sides. In the case when the strips are opposite sides, the two members can be engageable with one another to adjust the length of the cord 105 and/or to form a loop, as discussed above.

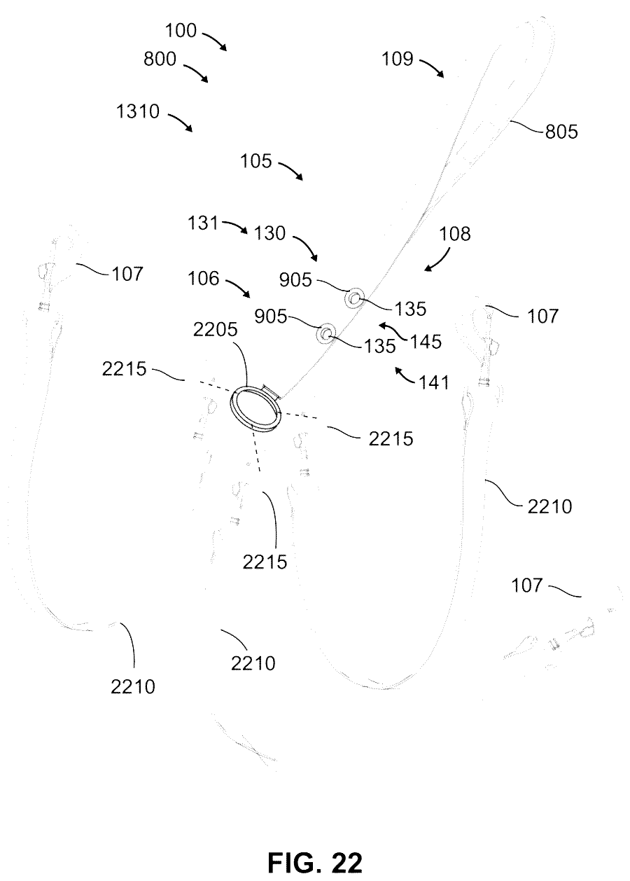

FIG. 22 shows another version of a pet leash system 100 in the form of a cord-based accessory attachment pet leash system 800. In this version, the cord-based accessory attachment pet leash system 800 is in the form of a multi-pet leash 1310. In this version, the cord 105 includes an attachment ring 2205. One or more multi-pet leashing members 2210 are connectable to the attachment ring 2205 by an attachment ring hooking member 2215. The attachment ring hooking member 2215 can be the same or similar to the pet hook 107. Optionally, the one or more multi-pet leashing members 2210 can additionally or alternatively include an accessory attachment mechanism 130.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A pet leash system comprising:
a cord comprising a length of material extending from a pet end to a handler end;
a hook connected to the cord at the pet end of the cord, the hook being adapted to connect the pet leash system to a pet to be walked by a handler;
a graspable member at the handler end, the graspable member being adapted to be grasped by the handler so the handler can control a pet connected to the hook; and
an accessory attachment mechanism in or on the cord,
wherein the accessory attachment mechanism is adapted to allow a handler to attach one or more accessories to the pet leash system so the accessories can be accessed while the handler is walking the pet.

2. A pet leash system according to claim 1 wherein the graspable member is a loop that is an extension of the cord.

3. A pet leash system according to claim 1 wherein the cord is flat or round and at least partially flexible.

4. A pet leash system according to claim 1 wherein accessory attachment mechanism is adapted to allow a handler to attach a plurality of accessories to pet leash system.

5. A pet leash system according to claim 1 wherein the accessory attachment mechanism is positioned on a body of the cord between the hook and the graspable member.

6. A pet leash system according to claim 1 wherein the accessory attachment mechanism includes at least a portion that is positioned on the graspable member.

7. A pet leash system according to claim 1 wherein the graspable member is a loop that is an extension of the cord and wherein the accessory attachment mechanism includes at least a portion that is positioned on the loop.

8. A pet leash system according to claim 1 wherein the accessory attachment mechanism comprises one or more of an aperture, a hook, a magnet, a snap, a button, and a hook and loop fastener.

9. A pet leash system according to claim 1 wherein the accessory attachment mechanism comprises one or more apertures that extend through a thickness of the cord.

10. A pet leash system according to claim 1 wherein the accessory attachment mechanism comprises a plurality of apertures that extend through a thickness of the cord.

11. A pet leash system according to claim 1 wherein the accessory attachment mechanism comprises an aperture that extends through a thickness of the cord, the aperture being formed by a grommet.

12. A pet leash system according to claim 1 wherein the accessory attachment mechanism comprises one or more apertures that extend through a thickness of the cord, the aperture having a round or polygonal shape.

13. A pet leash system according to claim 1 wherein the pet leash system further comprises one or more accessories, wherein the one or more accessories are adapted to be attached to the pet leash system using the accessory attachment mechanism.

14. A pet leash system according to claim 1 wherein the pet leash system further comprises one or more accessories and one or more connectors, wherein the one or more accessories are adapted to be attached to the pet leash system using the one or more connectors.

15. A pet leash system according to claim 1 wherein the pet leash system further comprises one or more connectors, wherein the one or more connectors are adapted to attach the one or more accessories to the pet leash system using the accessory attachment mechanism.

16. A pet leash system according to claim 1 wherein the pet leash system further comprises one or more accessories, wherein the one or more accessories are adapted to be attached to the pet leash system using the accessory attachment mechanism, and wherein the one or more accessory comprises one or more of a pet waste bag, a pet waste bag containing pet waste, hand sanitizer, sanitizing wipes, a portable water bowl, a container for snacks or treats, a flashlight, a reflector, pepper spray, a whistle, a water container, a key, and sunscreen.

17. A pet leash system comprising:
a cord comprising a length of material extending from a pet end to a handler end;
a hook connected to the cord at the pet end of the cord, the hook being adapted to connect the pet leash system to a pet to be walked by a handler;
a graspable member at the handler end, the graspable member being adapted to be grasped by the handler so the handler can control a pet connected to the hook; and
an accessory attachment mechanism in or on a body of the cord that extends between the hook and the graspable member, the graspable member, or both,
wherein the accessory attachment mechanism is adapted to allow a handler to attach one or more accessories to the pet leash system so the accessories can be accessed while the handler is walking the pet.

18. A pet leash system according to claim 17 wherein the graspable member is a loop that is an extension of the cord.

19. A pet leash system according to claim 17 wherein the graspable member is a loop that is an extension of the cord and wherein the loop is positionable around the waist or other body part of a handler so that the pet leash system can be secured in a hands free manner.

20. A pet leash system according to claim 17 wherein the accessory attachment mechanism comprises a plurality of attachment members, wherein the plurality of attachment members are spaced along the body of the cord.

21. A pet leash system according to claim 17 wherein the accessory attachment mechanism comprises a plurality of attachment members, wherein the plurality of attachment members comprises one or more attachment members along the body of the cord and one or more attachment members on the graspable member.

22. A pet leash system according to claim 17 wherein the accessory attachment mechanism comprises a plurality of attachment members, wherein two of the plurality of attachment members are connectable to one another.

23. A pet leash system according to claim 17 wherein the accessory attachment mechanism comprises a plurality of attachment members, wherein two of the plurality of attachment members are connectable to one another using a connector.

24. A pet leash system according to claim 17 wherein the accessory attachment mechanism comprises a plurality of attachment members, wherein the attachment members comprise one or more of an aperture, a hook, a magnet, a snap, a button, and a hook and loop fastener.

25. A pet leash system according to claim 17 wherein the pet leash system is a multi-pet leash system adapted to attach to multiple pets.

26. A pet leash system according to claim 17 wherein the pet leash system is a multi-pet leash system adapted to attach to multiple pets, wherein the cord is connected to a ring, and wherein multiple pet leashes can be connected to the ring.

27. A method of walking a pet, the method comprising:
providing a pet leash system, the pet leash system comprising:
a cord comprising a length of material extending from a pet end to a handler end;
a hook connected to the cord at the pet end of the cord, the hook being adapted to connect the pet leash system to a pet to be walked by a handler;
a graspable member at the handler end, the graspable member being adapted to be grasped by the handler so the handler can control a pet connected to the hook; and
an accessory attachment mechanism in or on the cord,
connecting the hook to a pet,
attaching one or more accessories to the cord, and
grasping the graspable member and walking the pet with the one or more accessories attached to the cord.
